(19) United States
(12) Patent Application Publication
(10) Pub. No.: US 2016/0173491 A1
(43) Pub. Date: Jun. 16, 2016

(54) METHOD AND SYSTEM FOR SHARING TWO-FACTOR AUTHENTICATORS TO ACCESS ELECTRONIC SYSTEMS

(71) Applicant: Cameron Moten, Rockville, MD (US)

(72) Inventor: Cameron Moten, Rockville, MD (US)

(21) Appl. No.: 14/967,530

(22) Filed: Dec. 14, 2015

Related U.S. Application Data
(60) Provisional application No. 62/090,941, filed on Dec. 12, 2014.

(51) Int. Cl. H04L 29/06; H04L 29/08

(52) U.S. Cl. CPC H04L 63/0846; H04L 67/1097

(57) ABSTRACT

A storage server is provided and configured to: receive a time-based access code from a computing device of a customer having an account with a resource provider, the time-based access code to be valid during a future time window and including a secret value provided by the resource provider; store the time-based access code; generate a URL linked to the stored time-based access code; send the URL to the customer to send to the third party to send to the storage server; receive the URL from the third party; and send the time-based access code to the third party only if the URL is received during the time window, whereupon the third party attempts to log into the resource provider and gains access to the account of the customer if the resource provider verifies the secret value and the time at which the login by the third party is attempted.

### RELATED APPLICATION DATA

The present application is related to commonly-assigned and co-pending U.S. Provisional Patent Application Ser. No. 62/090,941, entitled METHOD AND SYSTEM FOR SHARING TWO-FACTOR AUTHENTICATORS TO ACCESS ELECTRONIC SYSTEMS, filed on Dec. 12, 2014, which application is incorporated herein by reference in its entirety.

### TECHNICAL FIELD

The present invention relates generally to two-factor authentication and, in particular, to sharing two-factor authentication with another.

### BACKGROUND ART

With the number of electronic commerce transactions having exploded to tremendous numbers, protecting online accounts and records is a top priority for both customers and service providers. Access to online accounts, services, and websites can be secured by any of a number of methods. Perhaps the most common is for the customer to select a username and a password for the account service to store (single-factor authorization). Later, when the username and password are entered into appropriate fields on the access page of the account service's webpage, the account service checks the entries against its stored records. If the username and password match the records, it is assumed that the person seeking access is the account owner and access to the account is granted. While the username/password method provide some security, it can be breached, especially when customers use short, common, or easily guessed passwords.

A higher level of security is afforded by two-factor authorization (TFA), which is based on the customer providing two of three possible forms of identification: something the customer has, such as a card (possession factor); something the customer knows, such a code (knowledge factor); and something the customer “is,” such as a fingerprint (biometric factor). Commonly, a cellphone or smartphone is used as the possession factor. The customer begins to log in to the account service's website with a username and password. If the username and password are verified, the account service then sends a text message, containing a one-time code, to the customer's phone. Typically, the current time (time of issuance) is embedded in the one-time code. The customer then enters the code into the service's website within a specified period of time, such as 30 seconds, and if the code and time are verified, login is completed and access is granted.

In another method of TFA, a secret value is generated by the service and sent to the customer when the account is set up (a new secret value may be generated and sent periodically, such as every three months so that a secret value has a limited life). The secret value is stored by the customer on a computing device. When the customer wants to log in to the service, the customer enters his/her username and password and has the computing device generate a time-based code using the stored secret value. The time-based code is then sent to the service which verifies both the underlying secret value and the current time. If both are valid, access is granted.

### SUMMARY OF THE INVENTION

The present invention provides a method for granting a third party access to a customer account with a resource provider, comprising storing a time-based access code on a storage server, the time-based code having been generated on a computing device of the customer, the time-based access code to be valid during a future time window and including a secret value provided to the customer by the resource provider; storing the time-based access code on the storage server; generating at the storage server a URL linked to the stored time-based; sending the URL to the customer to send the URL to the third party to send to the storage server during the time window; receiving at the storage server the URL sent by the third party; and, sending the time-based access code to the third party only if the URL is received by the storage server during time window, whereupon the third party attempts to log into the resource provider with the time-based access code and gains access to the customer account if the resource provider, having decoded the time-based code, verifies the secret value and the time at which the login by the third party is attempted.

The present invention also provides a non-transitory computer-readable medium having program code for granting a third party access to an account established by a customer with a resource provider, the program code comprising instructions executable by a computing device of the customer for: receiving a secret value generated by the resource provider, the secret value also being stored by the resource provider in a database; receiving an entry from the customer comprising a future time window; generating a time-based access code including the secret value to be valid during the future time window; sending the time-based access code to a storage server; receiving a URL from the storage server comprising a link to the time-based access code stored on the storage server; sending the URL to the third party to send to the storage server during the time window after which the third party receives the time-based access code from the storage server only if the URL is received by the storage server during the time window, whereupon the third party is allowed to attempt to log into the resource provider with the time-based access code and gain access to the customer account if the resource provider verifies the secret value and the time at which the login by the third party is attempted.

The present invention also provides a storage server, configured to receive a time-based access code from a computing device of a customer having an account with a resource provider, the time-based access code to be valid during a future time window and including a secret value provided to the customer by the resource provider; store the time-based access code; generate a URL linked to the stored time-based access code; send the URL to the customer to send to the third party to send to the storage server during the time window; receive the URL from the third party; and send the time-based access code to the third party only if the URL is received during the time window, whereupon the third party attempts to log into the resource provider with the time-based access code and gains access to the account of the customer if the resource provider verifies the secret value and the time at which the login by the third party is attempted.

### BRIEF DESCRIPTION OF THE DRAWINGS

FIG. 1 is a block diagram of an embodiment of a system for sharing two-factor authenticators to access electronic systems according to the present invention; and

FIG. 2A-2C are a flowchart of an embodiment of a method for sharing two-factor authenticators to access electronic systems according to the present invention.

### DETAILED DESCRIPTION OF THE PREFERRED EMBODIMENT

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components and so forth. In other instances, well-known structures, materials, or operations are not shown or described in detail to avoid obscuring aspects of the invention.

It will be appreciated that while single- and two-factor authorization methods limit access to an online account of a customer, security will be jeopardized if the customer allows a third party to access the account as the customer must provide the third party with the information necessary to access the account. Whether this is done in person, by phone, by e-mail, or by text message, there must be some transmission of the access information between the two parties. Embodiments of the present invention provide a secure system and method for sharing access information.

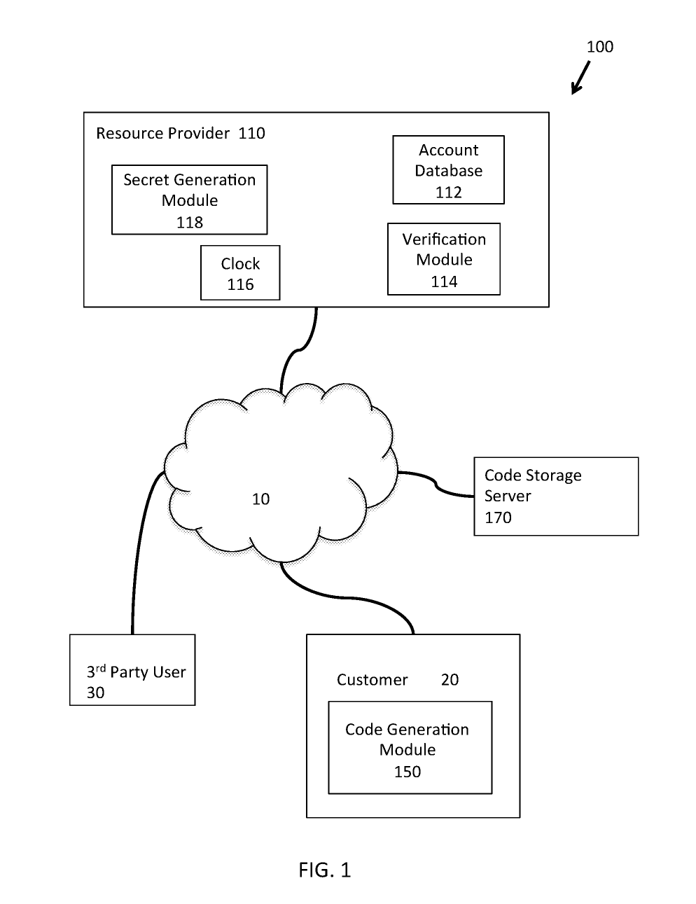

FIG. 1 is a block diagram of an embodiment of a system 100 for sharing two-factor authenticators to access to an electronic resource provider 110 according to the present invention. The system 100 includes the resource provider 110 and a code generation module 150 associated with a customer 20. The resource provider 110 and code generation module 150 may be coupled through, for example the internet 10. The resource provider 110 may be any online entity that provides customers, such as the customer 20, with a resource or service. Online examples include, but are not limited to, banks, shopping stores, auctions, classified advertising, e-mail providers, photo sharing, and any other type of e-commerce entity for which customers establish secure accounts. The system 100 further includes a code storage server 170 configured to store codes received from the customer 20 and send them to any third party user 30 designated by the customer 20.

The resource provider 110 includes an account database 112 in which is stored account and login information for each customer, among other items. The resource provider 110 also includes a verification module 114, which is configured to verify the identity and access permission of anyone trying to log in to an account. The resource provider 110 further includes a clock 116 and a secret value generation module 118, which is configured to generate access codes (secret values) for customers. The resource provider 110 may also include the code storage server 170 or the code storage server 170 may be part of a service provided by an independent entity.

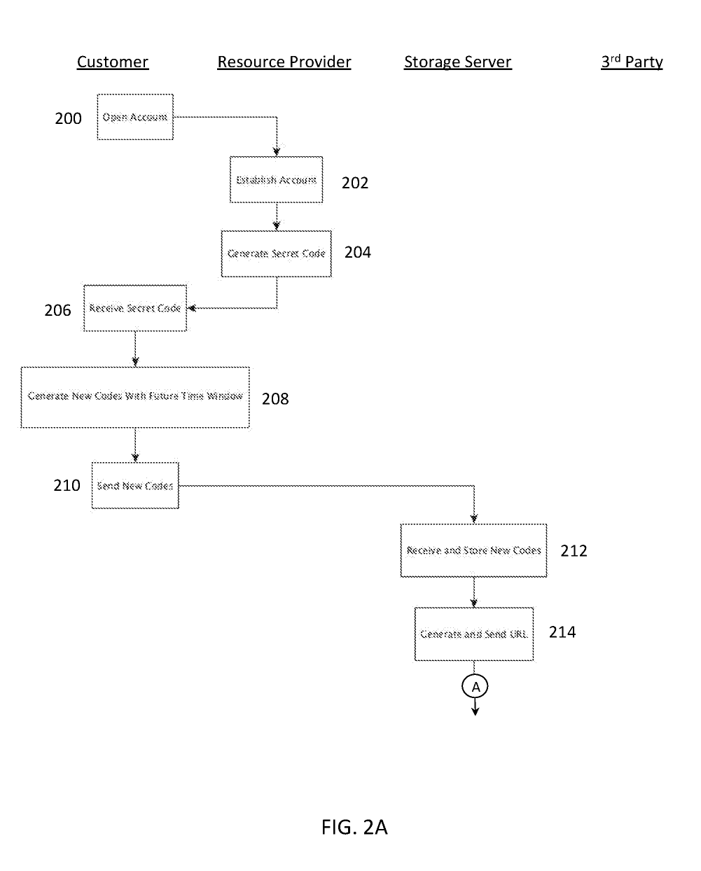

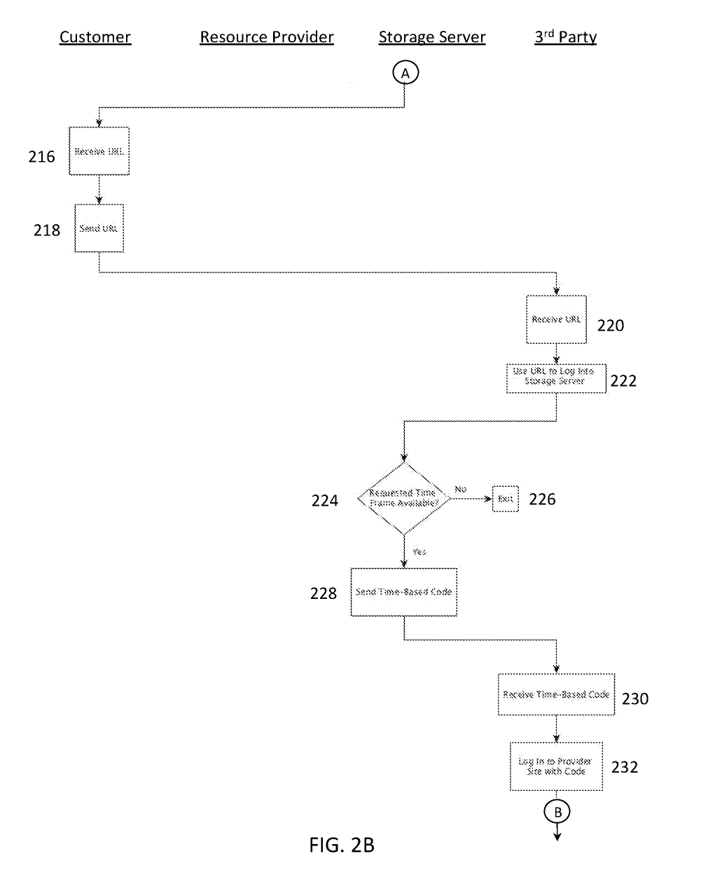

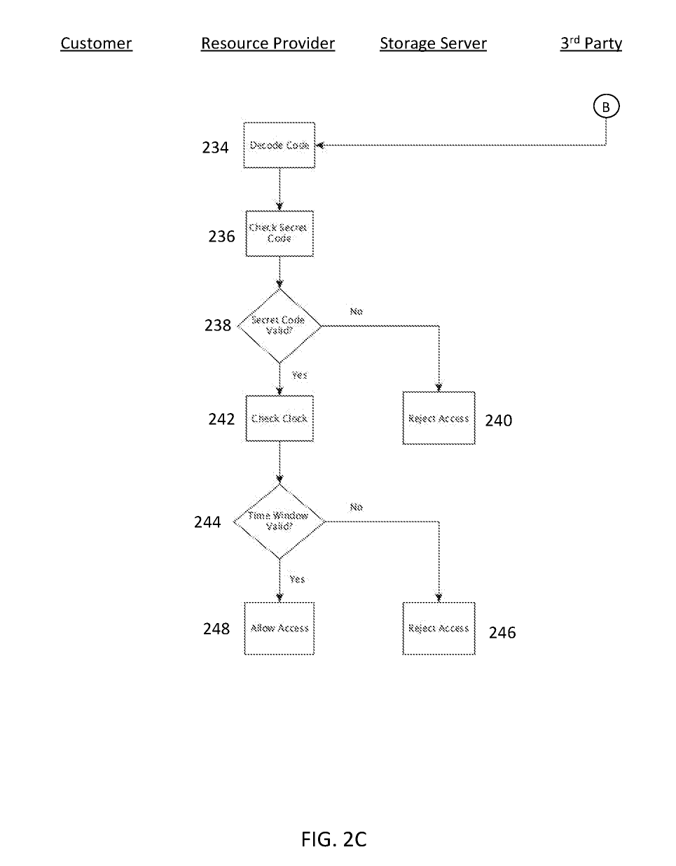

An embodiment of a secure method for sharing access information is illustrated in the flowchart of FIGS. 2A-2C. Columns of the flowchart indicate what activities occur at customer, resource provider, and third party user locations. The customer 20 opens an account with the resource provider 110 (step 200) which, in turn, establishes the account (step 202), generates a secret value (step 204) using the secret value code generation module 118, and stores the account information in the database 112. The secret value is sent to the customer 20 who receives the secret value (step 206). The customer 20 is able to use the value him/herself in the conventional TFA manner. However, if the customer 20 wants to allow the third party 30 temporary access to the account, the customer 20 uses the code generation module 150 to generate a new, temporary access code (step 208) that includes the secret value. The code generation module 150 may be an application loaded onto the customer's computer, smartphone, tablet, or other computing device on which the secret value generated by the resource provider 110 has been stored. The customer 20 selects a time in the future (start time), or a set of times, at or during which the customer 20 will allow the third party 30 to access the account. Typically, a time window of, for example, 30 seconds beginning at the start time will be provided so that the third party 30 will not have to log in exactly at the start time. In one embodiment, the start time may be input directly into the application as a combination of a date and time. In another embodiment, the start time may be input as a specified number of minutes, hours, or days in the future. The application combines the start time with the stored secret value to generate a new access code (step 208). Optionally, the application may generate a series of new access codes beginning at different or sequential times, such as three 30-second intervals.

The customer 20 may then send the new access codes to the storage server 170 (step 210) where they are stored (step 212). The storage server 170 generates a URL linked to the codes and which may be used to access the codes. The storage server 170 sends the URL back to the customer 20 (step 214) who receives the URL (step 216). When the customer 20 wishes to grant access to the account to the third party 30, the customer 20 sends the URL (step 218) to the third party who receives it (step 220). The URL may be sent as a text message, e-mail, or other form of communication. At a time or in the time frame indicated by the customer 20, the third party 30 uses the URL to access the storage server 170 website (step 222). The storage server 170 checks the current time against the time frame indicated by the new codes to be sure that the current time is within the allowed time frame (step 224). If it is not, the access is rejected and the process exits (step 226). If the current time is within the allowed time frame, the storage server 170 sends one of the stored access codes to the third party (step 228) who receives the code (step 230).

At the selected start time or within the allowed time window, the third party 30 begins to log in to the resource provider 110 using the new access code sent by the storage server 170 (step 232). In the verification module 114 at the resource provider 110, the original secret value is separated from the start time (step 234). The verification module 114 then determines (step 236) if the secret value is valid (step 238) and, if not, rejects the third party's 30 attempt to access the account (step 240). If the verification module 114 determines that the secret value is valid (step 238), the verification module 114 then uses the clock 116 (step 242) to determine if the third party 30 has logged in within the correct time window (step 244) and, if not, rejects the third party's 30 attempt to access the account (step 246). If the third party 30 has logged in within the correct time window, the verification module 114 allows the third party 30 to access the account (step 248). In this manner, the customer's secret value is only transmitted once, when the resource provider 110 sends it to the customer 20 and the third party 30 never sees it. And, because the code that the third party 30 receives and uses to access the account is time limited, it may not be used again after the time has expired.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. Moreover, although described above with respect to methods and systems, the need in the art may also be met with a non-transitory computer-readable medium having program code containing instructions executable by a computing device of the customer for granting a third party access to a customer account with a resource provider.

What is claimed is:

1. A method for granting a third party access to a customer account with a resource provider, comprising:
receiving at a storage server a time-based access code from a computing device of a customer having an account with the resource provider, the time-based access code to be valid during a future time window and including a secret value provided to the customer by the resource provider;
storing the time-based access code on the storage server;
generating at the storage server a URL linked to the stored time-based access code;
sending the URL to the customer to send the URL to the third party to send to the storage server during the time window;
receiving at the storage server the URL sent by the third party; and
sending the time-based access code to the third party only if the URL is received by the storage server during the time window, whereupon the third party attempts to log into the resource provider with the time-based access code and gains access to the customer account if the resource provider, having decoded the time-based code, verifies the secret value and the time at which the login by the third party is attempted.

2. The method of claim 1, wherein the future time window comprises a time specified by the customer.

3. The method of claim 1, wherein the future time window comprises a period of time beginning at a future date and time specified by the customer.

4. The method of claim 1, wherein the future time window comprises a period of time beginning at a future date and time specified by the customer.

5. The method of claim 1, wherein the future time window comprises a period of time beginning a number of minutes, hours, or days in the future specified by the customer.

6. A non-transitory computer-readable medium having program code for granting a third party access to an account established by a customer with a resource provider, the program code comprising instructions executable by a computing device of the customer for:
receiving a secret value generated by the resource provider, the secret value also being stored by the resource provider in a database;
receiving an entry from the customer comprising a future time window;
generating a time-based access code including the secret value to be valid during the future time window;
sending the time-based access code to a storage server;
receiving a URL from the storage server comprising a link to the time-based access code stored on the storage server;
sending the URL to the third party to send to the storage server during the time window after which the third party receives the time-based access code from the storage server only if the URL is received by the storage server during the time window, whereupon the third party is allowed to attempt to log into the resource provider with the time-based access code and gain access to the customer account if the resource provider verifies the secret value and the time at which the login by the third party is attempted.

7. The computer-readable medium of claim 6, wherein the future time window comprises a specific time.

8. The computer-readable medium of claim 6, wherein the future time window comprises a period of time beginning at a future date and time.

9. The computer-readable medium of claim 6, wherein the future time window comprises a period of time beginning at a future date and time.

10. The computer-readable medium of claim 6, wherein the future time window comprises a period of time beginning a number of minutes, hours, or days in the future.

11. A storage server, configured to:
receive a time-based access code from a computing device of a customer having an account with a resource provider, the time-based access code to be valid during a future time window and including a secret value provided to the customer by the resource provider;
store the time-based access code;
generate a URL linked to the stored time-based access code;
send the URL to the customer to send to the third party to send to the storage server during the time window;
receive the URL from the third party; and
send the time-based access code to the third party only if the URL is received during the time window, whereupon the third party attempts to log into the resource provider with the time-based access code and gains access to the account of the customer if the resource provider verifies the secret value and the time at which the login by the third party is attempted.

12. The storage server of claim 11, wherein the future time window comprises a time specified by the customer.

13. The storage server of claim 11, wherein the future time window comprises a period of time beginning at a future date and time specified by the customer.

14. The storage server of claim 11, wherein the future time window comprises a period of time beginning at a future date and time specified by the customer.

15. The storage server of claim 11, wherein the future time window comprises a period of time beginning a number of minutes, hours, or days in the future specified by the customer.
